(19) United States
(12) Patent Application Publication
(10) Pub. No.: US 2006/0002255 A1
(43) Pub. Date: Jan. 5, 2006

(54) Optimized audio / video recording and playing system and method

(76) Inventors: Yung-Chiuan Weng, Taipei Hsien (TW); Chia-Ho Lin, Taipei Hsien (TW)

Correspondence Address: HARNESS, DICKEY & PIERCE, P.L.C., P.O. BOX 8910, RESTON, VA, 20195, US

(21) Appl. No.: 11/047,571

(22) Filed: Feb. 2, 2005

Related U.S. Application Data
(63) Continuation-in-part of application No. 10/880,647, filed on Jul. 1, 2004.

(51) Int. Cl. G11B 15/52; G11B 5/09

(52) U.S. Cl. 369/47.1; 369/59.1

(57) ABSTRACT

An optimized audio/video recording and playing system and method executed on the computer executable platform, which is capable of optimally recording various stream files into a recording medium during the recording process based on optimized image resolution, sound sampling rate, the display settings of the display device and the sound settings of the acoustic device. During the playing process, the disclosed technology is capable of selecting the most appropriate stream file to play from the recording medium based on the system resources information, the display setting of the display device, and the sound setting of the acoustic device, so as to achieve the effect of optimized playing.

### CROSS-REFERENCE TO RELATED APPLICATIONS

This application is a continuation-in-part patent application of U.S. application Ser. No. 10/880,647 filed on Jul. 1, 2004, the entire contents of which are hereby incorporated by reference for which priority is claimed under 35 U.S.C. § 120.

### BACKGROUND OF THE INVENTION

1. Field of the Invention

The invention relates to an optimized audio/video recording and playing system and method, which is capable of automatically performing optimized recording based on the audio/video file, display settings and sound settings, and is also capable of automatically performing optimized playing based on the system resources, display settings and sound settings.

2. Related Art

With the rapid development of audio/video technology and the increasing demand for multimedia applications, conventional analog audio/video recording technology is not sufficient to meet the modern requirements. Therefore, in its place is the development and emergence of the fully digitalized DVD video recording technology of the Digital Versatile Disc (DVD) or the so-called Digital Video Disc (DVD). By making use of this modern digital audio/video recording technology, images and sounds of superior quality can be recorded.

However, in live play of digital audio/video programs it is found that performance is liable to suffer from the restrictions of the playback hardware. For example, usually in executing the play of programs using computers, it is likely that there will be few system resources left for playing since the computer is busy executing numerous other application processes. In this situation, it is very difficult if not impossible to play audio/video programs with high resolution and high sampling rate, and any such attempt would not only adversely affect the play quality of the audio/video programs, but would also affect the normal execution of other processes. In addition, when playing audio/video programs on certain platforms (for example, digital player), it often happens that the limited display and sound output capabilities are not capable of playing audio/video files with high resolution and high sampling rate, thus resulting in the failure of program playback.

To prevent the above-mentioned problems, users usually adopt the solutions of lower resolution and lower sampling rate in the recording of the audio/video file to meet the restrictions of most playing hardware. However, by doing so, it causes the distortion of the original audio/video signal, and even when sufficient system resources and high performance hardware are available, the user cannot obtain and enjoy high quality playing because there are no high quality audio/video files available for playing, thus resulting in a waste of valuable hardware resources.

Therefore, it is important to research and develop an optimized audio/video recording and playing system, which is capable of recording programs intelligently with optimized combination of various audio/video resource parameters during program recording, and is also capable of intelligently selecting and playing the optimized audio/video program files during playing, so that users may enjoy the best program quality and performance by making use of the computer executable platform of the system.

### SUMMARY OF THE INVENTION

In view of the above-mentioned problems and shortcomings of the prior art, the object of the invention is to provide an optimized audio/video recording and playing system and method, which is capable of achieving the following objectives:
(1) In the audio/video recording process, it optimally records the various stream files in the recording medium based on the combination of various recording parameters, such as the image resolution and the sound sampling rate of the audio/video file, the display settings of the display device, and the sound settings of the acoustic device.
(2) In the audio/video playing process, it plays the optimized programs by automatically selecting the most appropriate audio/video files from the recording medium based on the combination of playing parameters, such as the information of system resources, the display settings of the display device, and the sound settings of the acoustic device.

Therefore, through the application and implementation of the above-mentioned optimized audio/video recording and playing mechanism, users can enjoy the optimized audio/video effect by making use of a computer executable platform. Meanwhile, the execution load of the computer executable platform can be monitored and maintained real time, so as to achieve an optimized playing effect while maintaining stable operation in the computer executable platform.
(1) To achieve the above-mentioned objective, the invention provides an optimized audio/video recording and playing system, mainly comprising:
(2) an operating module, which is used for enabling the user to operate and execute recording and playing of audio/video programs;
(3) a retrieving module, which is used for retrieving the audio/video source file or stream file (including the stream file information) according to the selection and operation of the user;
(4) a recording module, which is used for optimally recording data received from the audio/video source file into the recording medium;
(5) a playing module, which is used for selecting the stream file and perform optimized playing according to the system resources information of the computer executable platform and the settings of the hardware.

Meanwhile, the invention provides an optimized audio/video recording method, comprising the following steps: reading the audio/video source file from the computer executable platform as selected by the user; analyzing the audio/video source file to obtain the maximum image resolution value and the maximum sound sampling rate; reading the display setting resolution value of the display device and the sound setting sampling rate of the acoustic device; recording the optimized stream file into the recording medium according to the maximum image resolution value and the maximum sound sampling value; recording the standard stream file onto the recording medium according to the display setting resolution value and the sound setting sampling value; storing the maximum image resolution value, maximum sound sampling value of the optimized stream file, the display setting resolution value and sound setting sampling value into the specific stream file; and recording it into the recording medium.

The recording method of other possible embodiments includes: recording the optimized stream file and the standard stream file based on the maximum image resolution value of the audio/video source file and the display setting resolution value of the display device as the recording parameters.

In addition, the invention provides another optimized playing method, comprising the following steps: loading the stream file information from the recording medium; reading the system resource information from the computer executable platform; if the value of the system resources information is less than the optimized playing threshold value, playing directly the standard stream file, and if the value of the system resources information is greater than the optimized playing threshold value, then reading the display setting resolution value from the display device and sound setting sampling value from the acoustic device respectively; playing the standard file when the display setting resolution value and the sound setting sampling value indicate that the system is incapable of plays the optimized stream file, and playing the optimized stream file when the display setting resolution value or the sound setting sampling value indicate that the system is capable of playing the optimized file.

Another playing method of a possible embodiment includes the following steps: playing based on the display setting resolution value of the display device as the only parameter in determining whether to play the optimized stream file or the standard stream file. Another playing method of a possible embodiment includes: playing based on the display setting resolution value of the display device and sound setting sampling value of the acoustic device as the parameters in determining whether to play the optimized stream file or the standard stream file.

The characteristics and implementation of the invention will be described in detail with reference to the embodiments in conjunction with the attached drawings.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic diagram of the optimized audio/video recording and playing system of the invention;

FIG. 2A is a flowchart of the optimized audio/video recording method according to the first embodiment of the invention;

FIG. 2B is a flowchart of the optimized audio/video recording method according to the second embodiment of the invention;

FIG. 3A is a flowchart of the optimized audio/video playing method according to the first embodiment of the invention;

FIG. 3B is a flowchart of the optimized audio/video playing method according to the second embodiment of the invention; and

FIG. 3C is a flowchart of the optimized audio/video playing method according to the third embodiment of the invention.

### DETAILED DESCRIPTION OF THE INVENTION

The invention relates to an optimized audio/video recording and playing system and method, which is performed on a computer executable platform 50.

During the audio/video file recording process, the stream file is optimally recorded into the recording medium based on the image resolution value and the sound sampling rate of the audio/video file, the display setting of the display device, and sound setting of the acoustic device. During audio/video file playing, the appropriate stream file is automatically selected and read from the recording medium based on the system resources information, the display settings of the display device and the sound settings of the acoustic device, so as to achieve optimized playing.

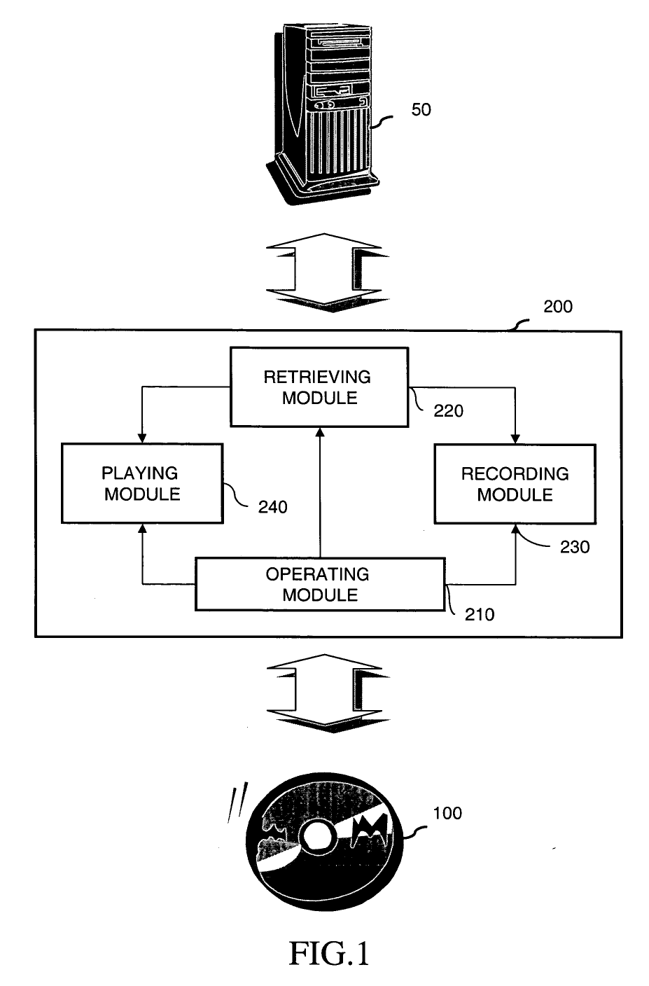

Refer to FIG. 1, which shows a schematic diagram of the optimized recording and playing system of the invention. As shown in FIG. 1, the optimized recording and playing system 200 of the invention is executed on a computer based platform 50. The so-called computer executable platform 50 is usually a personal computer or notebook computer having the attached recording and playing device (not shown) of the display device (not shown), the acoustic device (not shown), and the recording medium 100, which is used for storing and retrieving the playback programs into/from the recording medium 100.

As shown in FIG. 1, the basic framework of the optimized audio/video recording and playing system 200 comprises the following:

The operating module 210, provided with a user interface (not shown), which is used for receiving operation instructions from the user. Its major function is receiving the audio/video source file (or the audio/video source) selected by the user during the recording process, and during the playing process, the stream file information is selected and retrieved from the recording medium to carry out playing.

Audio/video recording and playing may also be handled entirely by the user, in addition to the above-mentioned audio/video source file selection. It may also be handled manually by the user in setting the various parameters used in the recording or playing processes, thus achieving customized audio/video recording and playing.

The retrieving module 220, which is used for performing file retrieval according to the operation instructions of the user input from the operating module 210. During the recording process, it reads the audio/video source file (or the audio/video source) received from the computer based platform 50; during the playing process, it is used for playing the user selected stream file loaded from the recording medium 100.

The recording module 230, which is used for recording the optimized stream file and the standard stream file into the storage medium 100 according to the various recording parameters.

In the first embodiment of the invention, optimized stream file recording mainly involves obtaining the maximum image resolution value and the maximum sound sampling value as the recording parameters by analyzing the audio/video source file. In the second embodiment, the only concern is acquiring the maximum image resolution value of the audio/video source file as the recording parameter. Thus, if the computer executable platform 50 of the audio/video recording and playing system has sufficient playing capability, it may choose the optimized stream file to play so that the user may enjoy optimized quality of the original audio/video programs.

When recording the standard stream file, the audio/video program is recorded with basic audio/video quality due to the limited playing capability of the computer executable platform 50 or its limited system resources. In the first embodiment of the invention, the display setting resolution value of the display device, and the sound setting sampling value of the acoustic device are used as the recording parameters. In the second embodiment, only the display setting resolution value is used as the recording parameter. As such, the recorded standard stream file is played by the computer executable platform 50 through its fundamental playing capability.

In addition, after the completion of optimized stream file and standard stream file recording, the recording module 230 further generates a specific stream file and stores it in a specific region of the recording medium 100. In the recording medium 100 are recorded the maximum image resolution value and the maximum sound sampling value of the optimized stream file and the display setting resolution value, and the sound setting sampling value of the standard stream file, so that the playing module 240 may be informed of the existence of various kinds of stream files in the recording medium 100 during the playing process, thus being able to select optimized playing.

Also, certain preset values can be recorded in this specific stream file. For example, the optimized playing threshold value may be recorded in the specific stream file to enable the computer executable platform 50 to determine and select the appropriate file to play based on its own system condition parameters. Thus, when the system resource value is less than said optimized play threshold value, the standard stream file is played. When the system resources value is greater than said optimized playing threshold value, the optimized stream file is played (the actual results may depend on the restrictions of other conditions).

In general, the information about the locations of the various stream files is recorded in the specific stream file to allow the playing module 240 to determine and select the stream file to play. Then it can readily locate and retrieve said stream file from the recording medium 100 for playing.

Basically, the contents of the specific stream file may be adjusted according to the various recording procedures, and selected information can be put into the specific stream file by the system developer depending on the actual requirements.

The playing module 240, which is used for selecting the most appropriate stream file from the recording medium 100 according to the various playing parameters, so as to realize optimized playing.

In the first embodiment, when the user selection is transmitted to the playing module 240 via the user interface. Before playing, the playing module 240 reads the data of the stream file from the specific region of the recording medium 100 and determines which file to play, the optimized stream file or the standard stream file, depending on the system resource conditions of the computer executable platform 50.

System resources information generated automatically by the computer executable platform 50 (which is used for monitoring and controlling the preset conditions of hardware and software of the computer executable platform 50) is utilized to evaluate system resource conditions. The playing module 240 then obtains from the specific stream file information the preset optimized playing threshold value (the evaluation item and the settings of the threshold value may be adjusted according to the conditions of various computer executable platforms). If after comparison it is found that the value of the system resources information is greater than the optimized playing threshold value, and then the computer executable platform has sufficient resources to perform the playing of the optimized stream file. Otherwise, if the value of the system resources information is less than the optimized playing threshold value, then the computer executable platform 50 does not have sufficient resources to play the standard stream file.

Even if the computer executable platform 50 does have sufficient system resources, other system conditions must be considered, such as the restrictions of the display setting resolution value of the attached display device and the sound setting sampling value of the attached acoustic device of the computer executable platform 50. If the image display capability and sound play capability are sufficient, then the optimized stream file is played; otherwise, the standard stream file is played.

In the second embodiment, the playing module 240 determines whether to play the optimized stream file or the standard stream file according to the display setting resolution value of the display device and the sound setting sampling value of the acoustic device. The system conditions of the computer executable platform 50 are not considered.

In the third embodiment, the play parameters of the playing module 240 are further restricted, and the playing of the optimized stream file or the standard stream file is determined according only to the display setting resolution value of the display device.

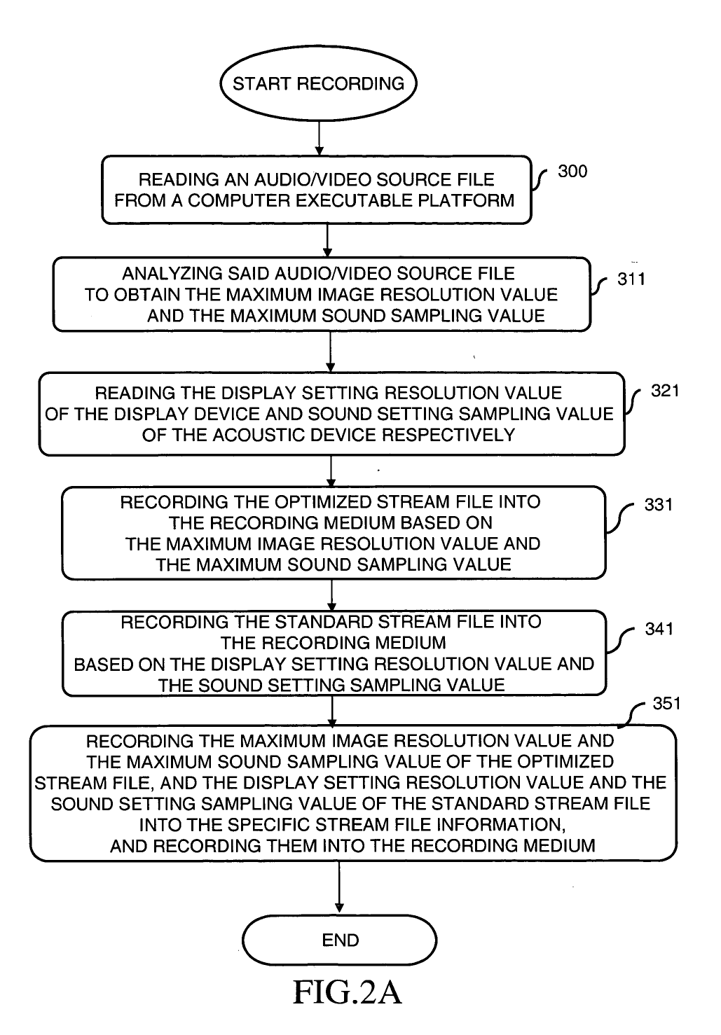

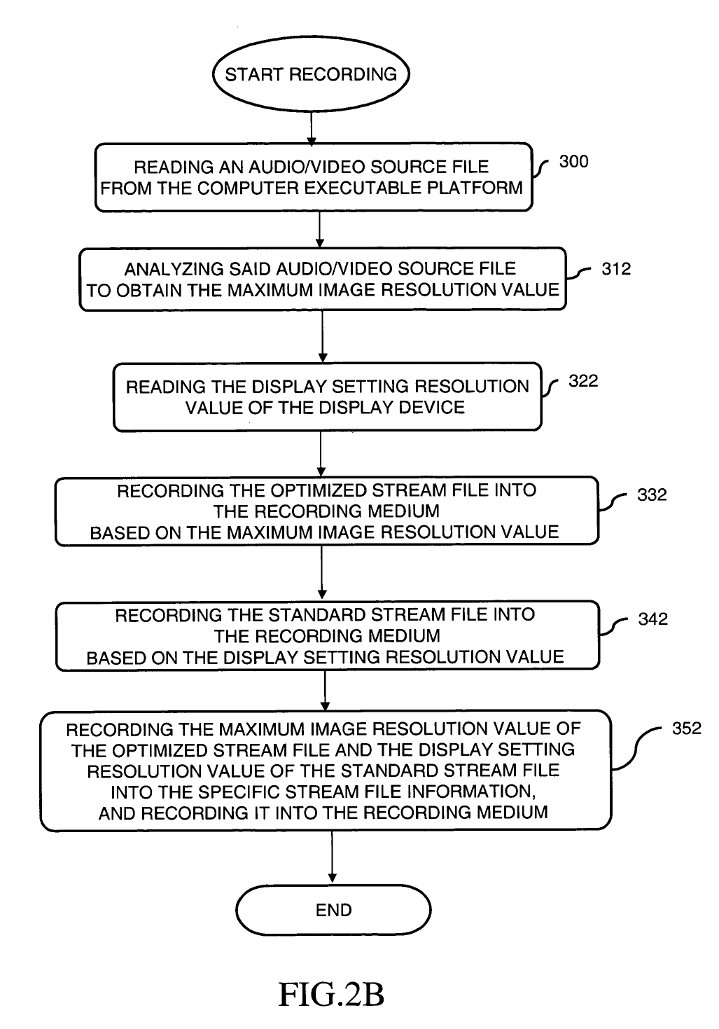

Refer to FIGS. 2A and 2B for the flowcharts of the recording method according to the first and second embodiments of the invention.

As shown in FIG. 2A, the recording method of the first embodiment comprises the following steps: reading the audio/video source file through the computer based platform 50 based on the user selection provided by the user interface (step 300); analyzing the audio/video source file, obtaining its maximum image resolution value and the maximum sound sampling value (step 311); then reading the display setting resolution value of the display device and the sound setting sampling value of the acoustic device of the computer executable platform 50, respectively (step 321); upon completion of reading and analyzing the audio/video source file, recording the optimized stream file and the standard streaming file, with the maximum image resolution value and the maximum sound sampling value of the audio/video source file used as the basis in recording the optimized stream file (step 331); then recording the ordinary standard stream file by making use of the display setting resolution value and the sound setting sampling value (step 341), and storing the resulting stream file onto the recording medium 100; and finally recording the maximum image resolution value, the maximum sound sampling value, display setting resolution value and sound setting sampling value in the specific stream file of the same recording medium 100 (step 351).

As shown in FIG. 2B, in the second embodiment of the invention, recording the optimized stream file and the standard streaming file is different from that of the first embodiment. That is, the execution of step 311 of the first embodiment is modified so as to analyze and obtain only the maximum image resolution value (step 312) to record the optimized stream file (step 332) of the second embodiment. The execution of step 321 of the first embodiment is modified so as to read only the display setting resolution value of the display device (step 322) of the second embodiment to record the ordinary standard stream file (step 342). Finally, the execution of step 351 of the first embodiment is modified so as to record only the maximum image resolution value and the display setting resolution value into the specific streaming file (step 352) of the second embodiment.

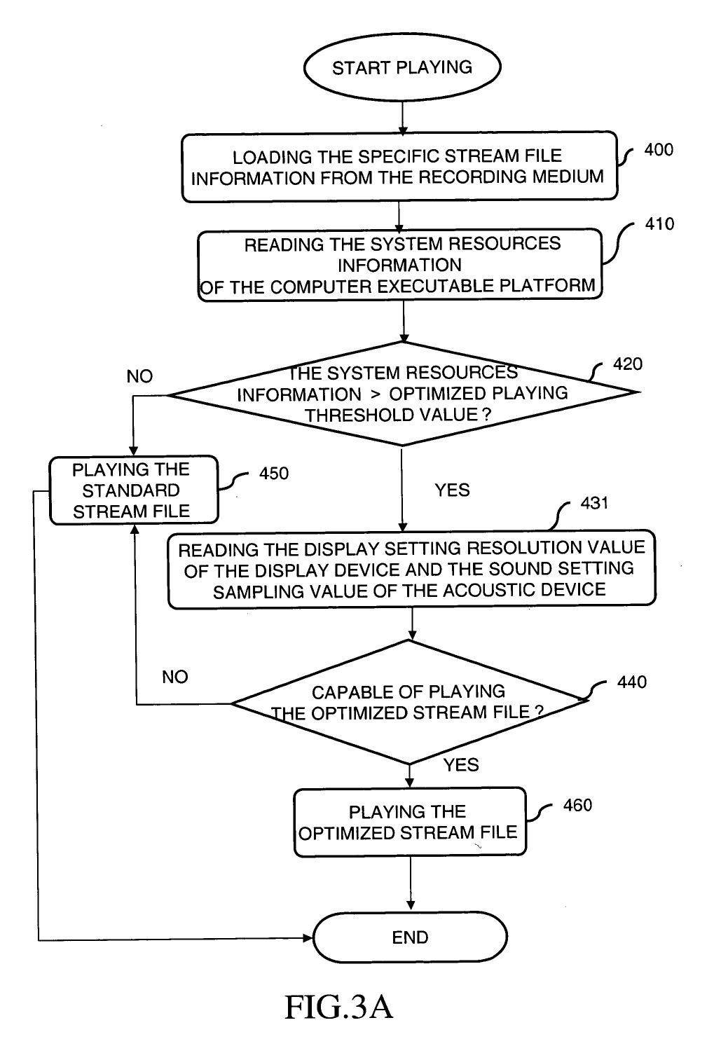

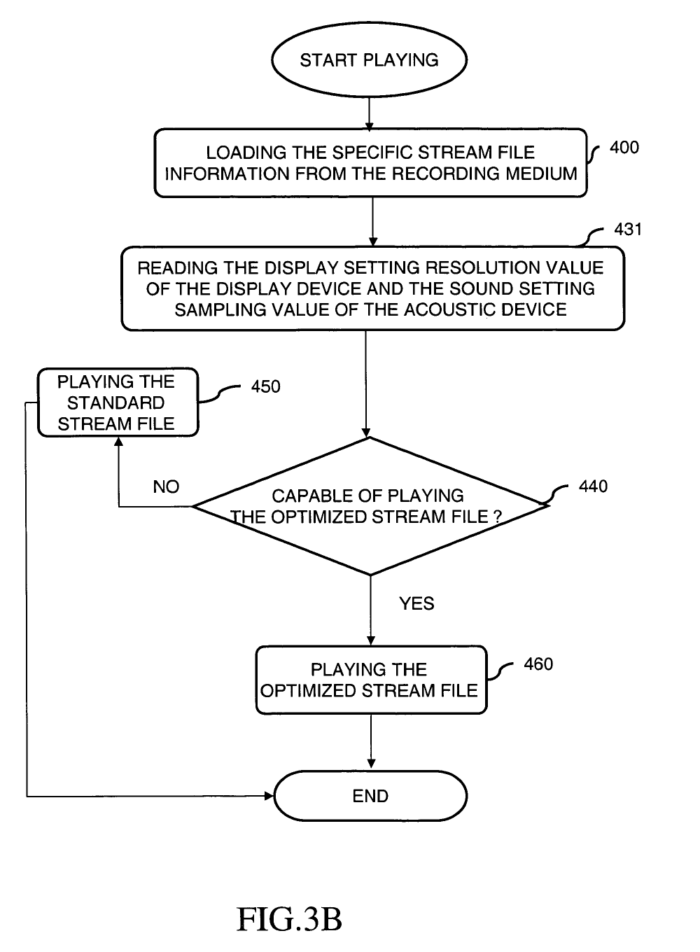

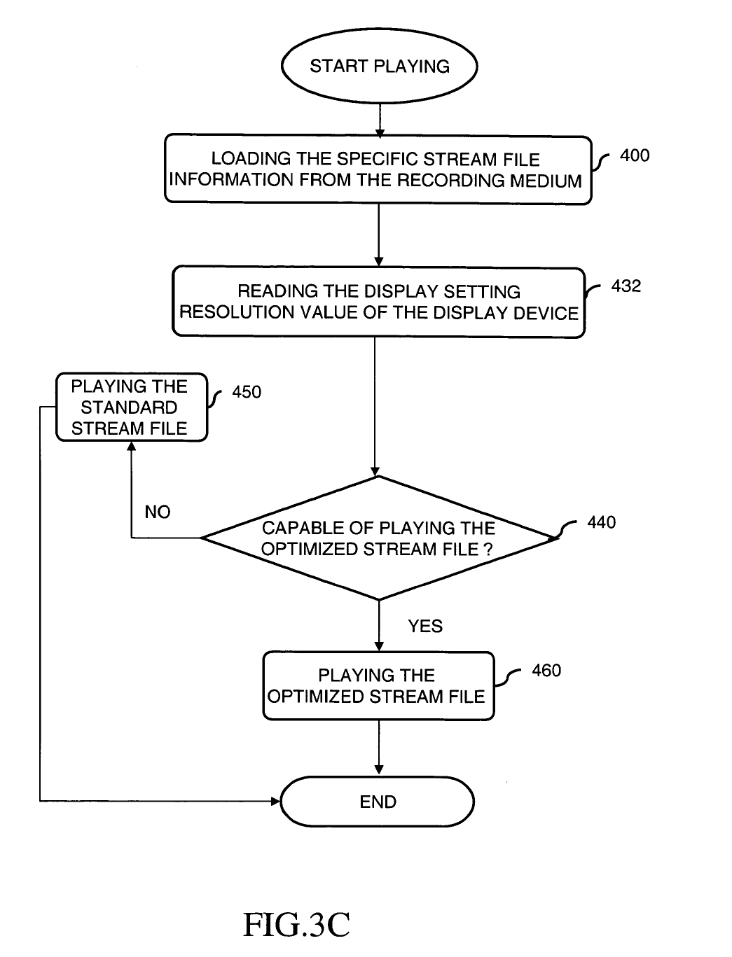

Refer to FIGS. 3A & 3B & 3C respectively for flowcharts of three different methods according to the first, second, and third embodiments of the invention.

As shown in FIG. 3A, the playing method of the first embodiment comprises the following steps: first, upon setting the recording medium 100 into the recording and playing device, the optimized audio/video recording and playing system 200 loads in the specific stream file information recorded with the preset maximum play threshold value, maximum image resolution value, maximum sound sampling value, display setting resolution value and sound setting sampling value.

Then, the optimized audio/video recording and playing system 200 is used for reading the system resources information from the computer executable platform 50 (step 410), which may be obtained from the operation system of the computer based platform. It is then determined whether the value of the system resources information is greater than the preset optimized playing threshold value (step 420). If it is determined that the value of the system resources is less than the optimized playing threshold value, then the computer based platform 50 is busy, and since it is not appropriate to play the optimized streaming file, it directly plays the standard stream file (step 450). If the value of the system resources information is greater than the optimized play threshold value, then the playing capability of the device is to be determined.

At this time, the system 200 reads the display setting resolution value of the display device and the sound setting sampling value of the acoustic device respectively to determine whether the existing display device and acoustic device are capable of playing the optimized stream file (step 440). If they are incapable of meeting the basic requirements of playing the optimized stream file, then the system 200 enters step 450, and directly plays the standard stream file. On the other hand, if they are capable of meeting the requirements of playing the optimized stream file, then the optimized stream file is selected and played (step 460).

FIG. 3B shows the playing process flow according to the second embodiment of the invention. As shown in FIG. 3B, the major difference between the second and first embodiments is that, in the second embodiment the system resources information of the computer executable platform 50 is not taken into consideration in the playing process flow, but rather the display setting resolution value of the display device and the sound setting sampling value of the acoustic device are read directly after step 400 to determine the playing file classification (step 431).

Thereafter, the process flow from steps 440-460 is the same as that of the first embodiment.

FIG. 3C shows the playing process flow according to the third embodiment of the invention. As shown in FIG. 3C, the major difference between the third and second embodiments is that, instead of step 431 of the second embodiment, the execution of the playing process is modified so that only the display setting analysis value is read from the display device as the basis for determining whether to play the optimized stream file or the standard stream file (step 432). The process flow of the steps from 440 to 460 is the same as that of the first embodiment and the second embodiment, so will not be repeated here. The first embodiment of the invention is described to explain further the recording/playing method of the invention.

Suppose that the maximum image resolution of the audio/video source file is 1280 pixels*160 pixels, with its maximum sound sampling value at 330000 Hz. In the recording process, the display setting resolution value of the computer based platform 50 is 800 pixels*600 pixels, with its sound setting sampling value at 330000 Hz. In the playing process, the display setting resolution value of the computer executable platform 50 is 1024 pixels*768 pixels, with its sound setting sampling value at the same 330000 Hz. In addition, in the playing process, the equipment availability rate of the system resources of the computer executable platform 50 is 90%, while the set optimized playing threshold value of the playing module 240 is 75%.

As shown in FIG. 2A, the process flow of the recording method of the invention comprises the following steps: first, the optimized audio/video recording and playing system 200 reads the audio/video source file through the computer based platform 50 as instructed by the user selection transmitted by the user operation interface (step 300); then, the audio/video source file is analyzed to obtain the maximum image resolution value (1280 pixels* 960 pixels) and maximum sound sampling value (33000 Hz) (step 311); at this time, the display setting resolution value (800 pixels*600 pixels) of the display device and the sound setting sampling value of the acoustic device (33000 Hz) are read (step 321); then the optimized stream file is recorded using the maximum image resolution value and the maximum sound sampling value (step 331); next, the display setting resolution value and the sound setting sampling value are used for recording the standard stream file into the storage medium (step 341); finally, the maximum image resolution value and the maximum sound sampling value of the optimized stream file, and the display setting analysis value and sound setting sampling value of the standard stream file are recorded in the specific stream file information, and stored in the specific region of the recording medium (step 351).

As shown in FIG. 3A, the process flow of the playing method of the invention comprises the following steps: upon determining the audio/video contents to be played as instructed by the user selection transmitted via the user operation interface, the optimized audio/video recording and playing system 200 loads in the specific stream file information from the recording medium 100 (step 400) to obtain related information (1280 pixels*960 pixels, 33000 Hz for the optimized stream file; 800 pixels*600 pixels, 33000 Hz for the standard streaming file) for the optimized stream file and standard stream file; then the system resources information is read from the computer executable platform 50 (step 410) to obtain the equipment available rate 90% of the computer executable platform 50; this rate is used for determining whether it is greater than the optimized playing threshold value 75% (step 420); through verification it is determined that this availability rate is greater than the optimized playing threshold value, which means that the play can be performed on the computer executable platform 50 without adversely affecting the execution of other procedures; the display setting resolution value (1024 pixel*768 pixel) of the display device and the sound setting sampling value (33000 Hz) of the acoustic device are read respectively (step 431), and these values are used for determining whether the computer executable platform 50 is capable of playing the optimized stream file (step 440). Since it is determined that the computer based platform is not capable of performing the optimized play (with the parameters of its specification less than 1280 pixels*960 pixels, 33000 Hz for the optimized stream file), therefore the playing module 240 automatically selects the standard stream file (800 pixels*600 pixels, 33000 Hz) to execute the play (step 450).

On the other hand, if it is determined that the playing capability of the computer based platform is greater than the specified value of the optimized stream file (step 440), then the playing module 240 automatically selects and plays the optimized stream file (step 460).

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An audio/video recording and playing system, executed on a computer executable platform, and provided with a user interface to execute the audio/video recording and playing of the audio/video stream files into the recording medium, comprising:
an operating module used for receiving the user operation via the user interface, providing the audio/video source file selected to be recorded by the user during the recording process, and providing the stream file information selected to be played by the user during the playing process;
a retrieving module used for reading said audio/video source file from the computer executable platform based on the user operation instructions transmitted via the user interface during the recording process, and loading said stream file information and the corresponding stream file during the playing process;
a recording module used for analyzing said audio/video source file to obtain a maximum image resolution value and a maximum sound sampling value during the recording process, so as to record an optimized stream file into the recording medium, and to record a standard stream file into the recording medium based on a display setting resolution value of the display device and a sound setting sampling value of the acoustic device; and
a playing module used for determining whether to play said optimized stream file or said standard stream file during the playing process based on a display setting resolution value of the display device, a sound setting sampling value of the acoustic device, and the system resources information of the computer executable platform.

2. The system of claim 1, wherein said recording module is further used for recording the specific stream file information into the recording medium during the recording process, where the specific stream file information is recorded with said maximum image resolution value and said maximum sound sampling value of said optimized stream file, and said display setting resolution value and said sound setting sampling value of said standard stream file.

3. The system of claim 2, wherein said specific stream file information further comprises an optimized playing threshold value which is provided to said playing module, and when the value of the system resources information is less than said optimized playing threshold value, said standard stream file is played.

4. The system of claim 1, wherein said playing module further plays said standard stream file when the value of the system resources information is greater than said optimized playing threshold value, and when said display setting resolution value and the sound setting sampling value indicate that said optimized stream file can not be played.

5. The system of claim 1, wherein said playing module further plays said optimized stream file when the value of the system resources information is greater than said optimized playing threshold value, and when said display setting resolution value and the sound setting sampling value indicate that said optimized stream file can be played.

6. An audio/video recording and playing system, executed on a computer executable platform, and provided with a user interface to execute the audio/video recording and playing of the audio/video stream files into the recording medium, comprising:
an operating module used for receiving the user operation via the user interface, providing the audio/video source file selected to be recorded by the user during the recording process, and providing the stream file information selected to be played by the user during the playing process;
a retrieving module used for reading said audio/video source file from the computer executable platform based on the user operation instructions transmitted via the user interface during the recording process, and loading said stream file information and the corresponding stream file during the playing process;
a recording module used for analyzing said audio/video source file to obtain a maximum image resolution value and a maximum sound sampling value during the recording process, so as to record an optimized stream file into the recording medium, and to record a standard stream file into the recording medium based on a display setting resolution value of the display device and a sound setting sampling value of the acoustic device; and
a playing module, used for determining whether to play said optimized stream file or said standard stream file during the playing process based on a display setting resolution value of the display device and a sound setting sampling value of the acoustic device of the computer executable platform.

7. The system of claim 6, wherein said recording module is further used for recording the specific stream file information into the recording medium during the recording process, where the specific stream file information is recorded with said maximum image resolution value and said maximum sound sampling value of said optimized stream file, and said display setting resolution value and said sound setting sampling value of said standard stream file.

8. An audio/video recording and playing system, executed on a computer executable platform, and provided with a user interface to execute the audio/video recording and playing of the audio/video stream files into the recording medium, comprising:
an operating module used for receiving the user operation via the user interface, providing the audio/video source file selected to be recorded by the user during the recording process, and providing the stream file information selected to be played by the user during the playing process;
a retrieving module used for reading said audio/video source file from the computer executable platform based on the user operation instructions transmitted via the user interface during the recording process, and loading said stream file information and the corresponding stream file during the playing process;
a recording module used for analyzing said audio/video source file to obtain a maximum image resolution value during the recording process, so as to record an optimized stream file into the recording medium, and to record a standard stream file into the recording medium based on a display setting resolution value of the display device; and
a playing module used for determining whether to play said optimized stream file or said standard stream file during the playing process based on a display setting resolution value of the display device.

9. The system of claim 8, wherein said recording module is further used for recording the specific stream file information into the recording medium during the recording process, where the specific stream file information is recorded with said maximum image resolution value of said optimized stream file, and said display setting resolution value of said standard stream file.

10. An audio/video recording and playing method, executed on a computer executable platform, and provided with a user interface to execute the audio/video recording of the audio/video stream files into the recording medium, comprising the following steps:
reading an audio/video source file through the computer executable platform;
analyzing said audio/video source file to obtain a maximum image resolution value and a maximum sound sampling value;
reading a display setting resolution value of the display device and a sound setting sampling value of the acoustic device respectively;
recording an optimized stream file into the recording medium based on the maximum image resolution value and said maximum sound sampling value; and
recording a standard stream file into the recording medium based on said display setting resolution value and said sound setting sampling value.

11. The method of claim 10, wherein said method further comprises the step of storing the maximum image resolution value and the maximum sound sampling value of said optimized stream file, and said display setting resolution value and said sound setting sampling value of said standard stream file into the specific stream file information of the recording medium.

12. An audio/video recording and playing method, executed on a computer executable platform, and provided with a user interface to execute the audio/video recording of the audio/video stream files into the recording medium, comprising the following steps:
reading an audio/video source file through the computer executable platform;
analyzing said audio/video source file to obtain a maximum image resolution value;
reading a display setting resolution value from the display device;
recording an optimized stream file into the recording medium based on the maximum image resolution value; and
recording a standard stream file into the recording medium based on said display setting resolution value.

13. The method of claim 12, wherein said method further comprises the step of storing the maximum image resolution value of said optimized stream file, and said display setting resolution value of said standard stream file into the specific stream file information of the recording medium.

14. An audio/video recording and playing method, executed on a computer executable platform, and provided with a user interface to execute the audio/video playing of the audio/video stream files into the recording medium, comprising the following steps:
loading the specific stream file information from the recording medium;
reading the system resources information from the computer executable platform;
directly playing said standard stream file when the value of the system resources information is less than the optimized playing threshold value; and
reading the display setting resolution value of the display device and the sound setting sampling value of the acoustic device when the value of the system resources information is greater than the optimized playing threshold value, wherein further comprising the following steps:
playing said standard stream file when said display setting resolution value and said sound setting sampling value indicating that the system is not capable of playing the optimized stream file; and
playing said optimized stream file when said display setting resolution value and said sound setting sampling value indicating that the system is capable of playing the optimized stream file.

15. The method of claim 14, wherein said specific stream file information is recorded with said optimized playing threshold value, said maximum image resolution value and said maximum sound sampling value of said optimized stream file, and said display setting resolution value and said sound setting sampling value of said standard stream file.

16. An audio/video recording and playing method, executed on a computer executable platform, and provided with a user interface to execute the audio/video playing of the audio/video stream files into the recording medium, comprising the following steps:
loading the specific stream file information from the recording medium;
reading a display setting resolution value of the display device and a sound setting sampling value of the acoustic device respectively, wherein further comprising the following steps:
playing said standard stream file when said display setting resolution value and said sound setting sampling value indicating that the system is not capable of playing the optimized stream file; and
playing said optimized stream file when said display setting resolution value and said sound setting sampling value indicating that the system is capable of playing the optimized stream file.

17. The method of claim 16, wherein said specific stream file information is recorded with the maximum image resolution value and the maximum sound sampling value of said optimized stream file, and said display setting resolution value and said sound setting sampling value of said standard stream file.

18. An audio/video recording and playing method, executed on a computer executable platform, and provided with a user interface to execute the audio/video playing of the audio/video stream files into the recording medium, comprising the following steps:
loading the specific stream file information from the recording medium;
reading a display setting resolution value of the display device, wherein further comprising the following steps:
playing said standard stream file when said display setting resolution value indicating that the system is not capable of playing the optimized stream file; and
playing said optimized stream file when said display setting resolution value indicating that the system is capable of playing the optimized stream file.

19. The method of claim 18, wherein said specific stream file information is recorded with the maximum image resolution value of said optimized stream file, and said display setting resolution value of said standard stream file.
